(19) United States
(12) Patent Application Publication
(10) Pub. No.: US 2024/0367119 A1
(43) Pub. Date: Nov. 7, 2024

(54) APPARATUS AND METHOD FOR ENHANCING DISSOLUTION OF GAS IN LIQUID AND USE

(71) Applicant: TEKNOLOGIAN TUTKIMUSKESKUS VTT OY, Espoo (FI)

(72) Inventors: Johannes Roine, VTT (FI); Tuula Kajolinna, VTT (FI); Kristian Melin, VTT (FI); Jarno Martikainen, VTT (FI)

(73) Assignee: TEKNOLOGIAN TUTKIMUSKESKUS VTT OY, Espoo (FI)

(21) Appl. No.: 18/552,624

(22) PCT Filed: Mar. 24, 2022
(86) PCT No.: PCT/FI2022/050189

§ 371 Date: Sep. 26, 2023

(30) Foreign Application Priority Data
Mar. 26, 2021 (FI) 20215343

(51) Int. Cl. B01F 25/314; B01F 23/23; B01F 23/232; B01F 25/10

(52) U.S. Cl. CPC B01F 25/31421; B01F 23/2319; B01F 23/232; B01F 25/103; B01F 25/3141; B01F 2215/0422; B01F 2215/0431

(57) ABSTRACT

The invention relates to an apparatus and a method for enhancing dissolution of gas in liquid. The apparatus comprises an outer structure and at least one inner structure, at least one gas inlet for injecting gas to a gas space between the outer and inner structures, a wall of the inner structure having holes with the gas arranged to flow through the holes into the inner structure, at least one liquid inlet for feeding liquid into the inner structure to provide a swirl flow arranged to capture gas bubbles of the gas from an inner surface of the wall to form a liquid-gas mixture, and the inner structure designed such that volume of space inside the inner structure increases in the direction of the liquid flow, and at least one outlet for discharging the liquid-gas mixture out from the apparatus. Further, the invention relates to the use of the apparatus.

### CROSS-REFERENCE TO RELATED APPLICATIONS

This application is a national phase entry of and claims priority to International Patent Application No. PCT/FI2022/050189 (filed 4 Mar. 2022), which claims priority to Finnish Patent Application No. 20215343 (filed 26 Mar. 2021), the entire disclosures of which are incorporated herein by reference.

### BACKGROUND

### Technical Field

The application relates to an apparatus defined in claim 1 and a method defined in claim 10 for enhancing dissolution of gas in liquid. Further, the application relates to a use of the apparatus defined in claim 14.

### State of Art

From the prior art different devices are known for dissolving gas in liquid and for absorbing gas. Further, it is known from the prior art that small gas bubbles can be formed, for example, by means of ejectors or by feeding a high-pressure gas through nozzles.

### BRIEF SUMMARY

The objective is to solve the above problems. Further, the objective is to disclose a new type of apparatus and method for dissolving gas in liquid. Further, the objective is to disclose the method and apparatus for improving the dissolution of gases in liquids. Further, the objective is to disclose the method and apparatus to form small gas bubbles effectively.

The apparatus, method and use are characterized by what are presented in the claims.

The apparatus for enhancing dissolution of gas in liquid comprises an outer structure, at least one inner structure inside the outer structure and a gas space between the outer structure and inner structure, and at least one gas inlet for injecting the gas to the gas space and from the gas space to the inner structure. Further, the apparatus comprises at least one liquid inlet for feeding the liquid into the inner structure to provide a liquid flow in the inner structure and to form a liquid-gas mixture. The inner structure may be designed such that volume of the space inside the inner structure increases in the direction of the liquid flow. Further, the apparatus comprises at least one outlet for discharging the liquid-gas mixture out from the apparatus. The method for enhancing dissolution of gas in liquid is performed by means of said apparatus.

### BRIEF DESCRIPTION OF THE DRAWINGS

The accompanying drawings, which are included to provide further understanding of the invention and constitute a part of this specification, illustrate some embodiments of the invention and together with the description help to explain the principles of the invention. In the drawings:

FIG. 1 is an apparatus according to one embodiment,

FIG. 2 is an apparatus according to another embodiment, and

FIG. 3 is an apparatus according to another embodiment.

### DETAILED DESCRIPTION

The apparatus for enhancing dissolution of gas in liquid may comprise an outer structure and at least one inner structure inside the outer structure, at least one gas inlet for injecting the gas to a gas space between the outer structure and inner structure, and a wall of the inner structure which comprises holes. The gas is arranged to flow through the holes into the inner structure. Further, the apparatus comprises at least one liquid inlet for feeding the liquid into the inner structure to provide a swirl flow and the swirl flow of the liquid is arranged to capture gas bubbles of the gas from an inner surface of the wall in order to form a liquid-gas mixture, which comprises small bubbles. The inner structure is designed such that volume of the space inside the inner structure increases in the direction of the liquid flow, for example to provide an even or constant flow in the inner structure. Further, the apparatus comprises at least one outlet for discharging the liquid-gas mixture out from the apparatus.

The method for enhancing dissolution of gas in liquid may comprise steps: using an apparatus which comprises an outer structure and at least one inner structure inside the outer structure and in which a wall of the inner structure comprises holes and in which the inner structure is designed such that volume of the inner space inside the inner structure increases in the direction of a liquid flow, injecting the gas via at least one gas inlet to a gas space between the outer structure and inner structure, arranging the gas to flow through the holes of the wall from the gas space to the inner structure, feeding the liquid via at least one liquid inlet into the inner structure to provide a swirl flow, and arranging the swirl flow of the liquid to capture gas bubbles of the gas from an inner surface of the wall in order to form a liquid-gas mixture, which comprises small bubbles, and discharging the liquid-gas mixture via at least one outlet out from the apparatus.

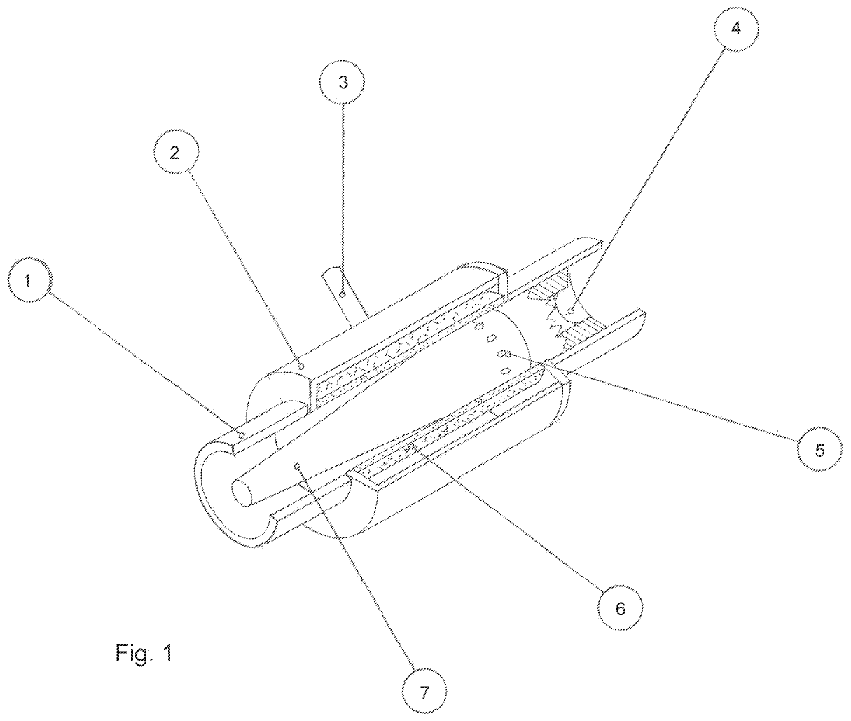

Some embodiments of the apparatus are shown in FIGS. 1, 2 and 3.

In this context, the outer structure means any outer structure, jacket, shell structure or the like which surrounds the inner structure or inner structures. In one embodiment, the outer structure may be a column, cylinder, chamber, pipe, tube, outer tube or pipe, jacket, cylindrical jacket, shell structure, plate shell structure, vessel or other suitable structure which surrounds the inner structure. In one embodiment, the outer structure may be formed from any suitable material, e.g. metal, steel, ceramic, composite, other suitable material or their combinations.

In one embodiment, the apparatus comprises one inner structure inside the outer structure. In one embodiment, the apparatus comprises two or more the inner structures inside the outer structure. Appearances of the outer structure and inner structure may be similar, or alternatively different. In one embodiment, the shape of the outer structure is similar than the shape of the inner structure, e.g. double pipe or other structure.

In this context, the inner structure means any inner structure comprising the wall which may be any wall, shell, jacket, or the like. In this context, the wall means wall or walls of the inner structure. The inner structure has a predetermined shape for forming the desired shape. In one embodiment, the inner structure can be a tube, pipe, hollow tube, flow channel, column, cylinder, chamber, flat, plate, or other suitable structure with any predetermined shape.

In one embodiment, the outer structure and inner structure are arranged on top of one another to form the apparatus with a desired shape, e.g. a double-pipe, plate-type or sandwich-type structure.

In one embodiment, the wall of the inner structure is porous and/or sinter structure. In one embodiment, the wall of the inner structure is formed from a screen or net. In one embodiment, the wall of the inner structure is formed from porous material. In one embodiment, the size of the holes in the wall of the inner structure is 1-100 μm. The size of the gas bubbles has an effect on the area of the gas bubbles, and the area of the gas bubbles has an effect on the dissolution rate.

In one embodiment, the gas space is arranged between the outer structure and the inner structure, and the gas is injected via one or more gas inlets to the space. The size or volume of the gas space between the inner structure and outer structure can vary depending on the process or the reaction which is performed. In one embodiment, the gas space is a chamber, e.g. annular chamber or plate chamber.

In one embodiment, the inner structure comprises a conical shaft, such as a conical inner shaft, which is tapering towards to the outlet. The conical shaft may be any conical structure, cone or the like. In one embodiment, the conical shaft is a solid structure. In one embodiment, the conical shaft is a hollow structure. In one embodiment, the position of the conical shaft can be adjusted in the inner structure by moving the conical shaft in longitudinal direction. In one embodiment, the conical shaft may be rotated. By means of the conical shaft in the inner structure the swirl flow of the liquid and the gas-liquid contact near the wall of the inner structure can be improved. Further, the conical shaft may lower the ambient pressure in the inner structure.

In one embodiment, a group of liquid inlets is arranged round the conical shaft.

In one embodiment, holes of the liquid inlets, e.g. nozzle or the like, are arranged such that the liquid which is fed through the liquid inlets achieves a spiraling flow profile and a swirl flow in the inner structure. Then gas bubbles can be captured from the inner surface of the wall effectively. In one embodiment, the liquid inlets or the holes of the liquid inlets are arranged to a desired angle to provide the swirl liquid flow inside the inner structure, for capturing gas bubbles of the gas. In one embodiment, the liquid inlets or the holes of the liquid inlets are arranged to a 35-55-degree angle, in one embodiment a 45-degree angle, to provide the swirl liquid flow. In one embodiment, the liquid inlets or the holes of the liquid inlets are arranged to a 35-55-degree angle, in one embodiment a 45-degree angle, in relation to longitudinal axis of the inner structure, e.g. in relation to longitudinal axis of a conical inner shaft, to provide the swirl liquid flow. In one embodiment, holes of the liquid inlets are arranged to a desired angle in relation to longitudinal axis of the inner structure, e.g. a conical inner shaft, and/or drilled radially to the liquid inlets comprising also holes in the flow direction. In one embodiment, the liquid inlet is a nozzle, nozzle hole, through hole or the like. In one embodiment, the size, shape and/or area of the opening can be adjusted in the liquid inlet. In one embodiment, the liquid is fed at a desired angle by means of the liquid inlets to provide the swirl liquid flow inside the inner structure.

In one embodiment, flow rate of the liquid flow is adjusted when the liquid is fed via the liquid inlets into the inner structure. In one embodiment, the flow rate of the liquid flow is 0.2-3 m/s, in one embodiment 0.3-2 m/s, and in one embodiment 0.5-1 m/s in the feeding.

In this context, the swirl flow means any swirl flow, spiral flow, vortex flow, helical flow, helix flow, spinning flow or the like.

In one embodiment, the liquid flow is introduced along inside the inner surface of the wall in the inner structure. In one embodiment, the liquid is fed via the liquid inlets to provide the swirl flow and to contact with the gas near the inner surface of the wall of the inner structure, wherein the swirl liquid flow captures, e.g. rinses, the gas bubbles of the gas from the inner surface of the wall to permit a diffusion the gas into the liquid. In one embodiment, the liquid flow is arranged to move along the inner surface of the wall by a centrifugal force for enhancing the capture and contact, such as the contact with the gas. In one embodiment, the gas bubbles are rinsed from the inner surface of the inner structure by means of the swirl flow and are arranged with the liquid to flow out from the apparatus. In one embodiment, the high-velocity swirl liquid flow shears the gas bubbles of the gas near the inner surface of the wall.

The liquid-gas mixture, which comprises small bubbles, e.g. micro-size bubbles, is formed. In one embodiment, the flow of the liquid-gas mixture is still in a spiral motion, when the liquid-gas mixture is discharged from the apparatus. Then the bubbles do not rise upwards, e.g. to surface, and thus, the bubbles do not collect to form bigger bubbles. When the bubbles are small, a big surface area between gas and liquid can be provided.

In one embodiment, the apparatus comprises a liquid feeding equipment comprising at least one device or the like. The liquid feeding equipment may comprise one or more pipe, piping, chamber, casing or another device. The liquid feeding equipment is connected up the liquid inlets in order to feed liquid to the liquid inlets. In one embodiment, a diameter of a liquid pipe can be narrowed before the liquid inlets, and then vacuum can be provided in the apparatus.

In one embodiment, the process comprises more than one apparatus.

In one embodiment, the apparatus comprises two or more inner structures. In one embodiment, the apparatus comprises two or more apparatus steps. In one embodiment, the injected gas is divided to two or more inner structure or apparatus step, and the liquid flow is fed from a previous inner structure or apparatus step to a next inner structure or apparatus step. In one embodiment, non-dissolved gas can be supplied to the next inner structure or apparatus step.

In one embodiment, the apparatus and the method can be used to dissolve desired gas in desired liquid in different industrial processes. In one embodiment, the apparatus is used in a gas-liquid separation process, chemical conversion process, dissolution of gas, CO₂ separation process, CO₂ capture process, crystallization of solids, precipitation process, biogas purification, biomethane purification, hydrogen injection for biological methanation, air or oxygen injection into liquid, e.g. in biological wastewater treatment, gas absorption process, ejector arrangement, aerobic sewage treatment, or their combinations. In one embodiment, the apparatus and method are used in CO₂ separation process, e.g. from methane, or CO₂ capture process, e.g. from flue gases. In one embodiment, the apparatus and method are used in hydrogen dissolving in liquid.

Thanks to the invention, the absorption and dissolution of the gas can be improved in the liquid. A high concentration of small bubbles can be produced in the liquid-gas mixture. Then the dissolution can be improved. For example, carbon dioxide can be dissolved effectively in the liquid. Further, gas-liquid separation can be improved by means of the invention.

Thanks to the apparatus structure, the dissolution or absorption can be accelerated. Further, a pressurization of the gas can be avoided. Then the processes can be carried out by means of smaller and cheaper devices.

The apparatus and the method offer a possibility to dissolve gas easily, and energy- and cost-effectively. The present invention provides an industrially applicable, simple and affordable way to dissolve gas in liquid in the different processes. The apparatus and the method are easy and simple to realize in connection with industrial production processes.

### Examples

Some embodiments of the apparatuses are shown in FIGS. 1-3.

The apparatus of FIG. 1 comprises an outer structure and an inner structure inside the outer structure and a gas space (2) between the outer structure and inner structure. The apparatus is formed from a double pipe. The gas space is an annular chamber. Further, the apparatus comprises a gas inlet (3) for injecting the gas to the gas space (2) between the outer structure and inner structure. Further, the apparatus comprises liquid feed pipe (4) and several liquid inlets (5) for feeding the liquid into the inner structure to provide a swirl flow. Further, the apparatus comprises an outlet (1) for discharging a liquid-gas mixture out from the apparatus.

A wall (6) of the inner structure comprises holes. The gas is arranged to flow through the holes from the gas space (2) into the inner structure. The wall (6) of the inner structure is a sinter structure which is formed from a net material. The size of the holes in the sinter structure is 3-6 μm in this example.

The liquid inlets (5) are nozzles which are arranged to a 35-55-degree angle, e.g. about 45-degree angle, to provide the swirl liquid flow inside the inner structure. The swirl flow of the liquid is arranged to capture gas bubbles of the gas from an inner surface of the wall (6) in order to form the liquid-gas mixture, which comprises small bubbles.

The inner structure is designed such that volume of the space inside the inner structure increases in the direction of the liquid flow. The inner structure comprises a conical inner shaft (7) which is tapering towards to the outlet. The nozzles (5) are arranged round the broad end of the conical shaft. Volume of the space inside the inner structure increases in the direction of the liquid flow. In the inner structure, a rate of the liquid-gas flow can be kept constant when a volume fraction of the gas increases.

The gas is injected continuously to the outer surface of the wall. From the outer surface the gas flows through the holes of the wall to the inner surface. The swirl flow of the liquid captures small initial gas bubbles from the inner surface of the wall, by means of a shear stress. The liquid-gas mixture with micro-size bubbles is provided in the inner structure, and the liquid-gas mixture is discharged via the outlet.

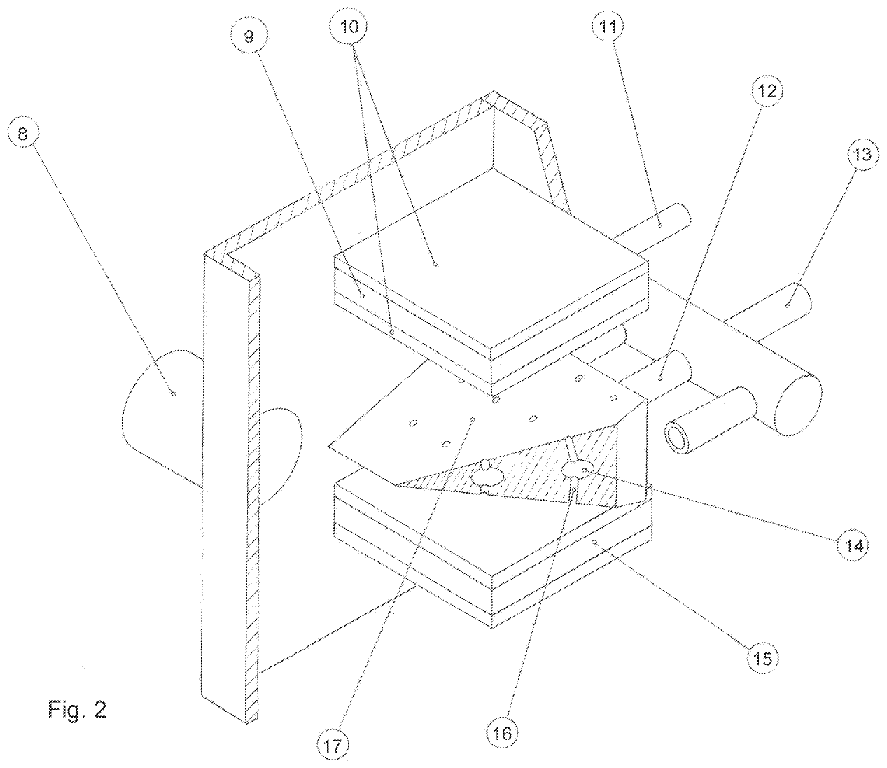

The apparatus of FIG. 2 is a sandwich-type apparatus. Apparatus of FIG. 2 comprises an outer structure with two outer structure layers and an inner structure inside the outer structure. The inner structure is arranged between the outer structure layers. The outer structure layers and inner structure are arranged on top of one another to form the sandwich-type structure. Further, the apparatus comprises two gas spaces (9,15) between the outer structure layer and inner structure. The gas spaces are flat chambers. Further, the apparatus comprises a gas inlet (11) for injecting the gas to the gas space (9,15) between the outer structure and inner structure. Further, the apparatus comprises liquid feeding equipment (12,13) comprising a piping and a chamber, and a nozzle arrangement (14,16) comprising several nozzles as liquid inlets in order to feed the liquid into the inner structure and to provide a swirl flow. Further, the apparatus comprises an outlet (8) for discharging a liquid-gas mixture out from the apparatus.

Porous plates (10) between the inner structure and the gas spaces comprise holes. The porous plates are walls of the inner structure. The gas is arranged to flow through the holes from the gas spaces into the inner structure.

The nozzles are arranged to a 35-55-degree angle, e.g. about 45-degree angle, to provide the swirl liquid flow inside the inner structure. The swirl flow of the liquid is arranged to capture gas bubbles of the gas from an inner surface of the inner structure, i.e. from the surface of the porous plate in order to form the liquid-gas mixture, which comprises small bubbles.

The inner structure is designed such that volume of the space inside the inner structure increases in the direction of the liquid flow. The inner structure comprises a conical inner shaft (17) which is a platy cone, and which is tapering towards to the outlet. The nozzles are arranged onto the outer surface of the conical shaft. Volume of the space inside the inner structure increases in the direction of the liquid flow. In the inner structure, a rate of the liquid-gas flow can be kept constant when a volume fraction of the gas increases.

The gas is injected continuously to the outer surface of the porous plate. From the outer surface the gas flows through the holes of the porous plate to the inner surface. The swirl flow of the liquid captures small initial gas bubbles from the inner surface of the porous plate inside the inner structure by means of a shear stress. The liquid-gas mixture with micro-size bubbles is provided in the inner structure, and the liquid-gas mixture is discharged via the outlet.

In the apparatus of FIG. 2, the inner structure comprising the platy cone is fitted between two outer structure layers comprising the gas flat chambers, and the inner structure and the outer structure layers are arranged on top of one another to form the sandwich-type structure. In the alternative embodiment, the apparatus can comprise a desired amount of the outer structure layers and inner structure layers on top of one another.

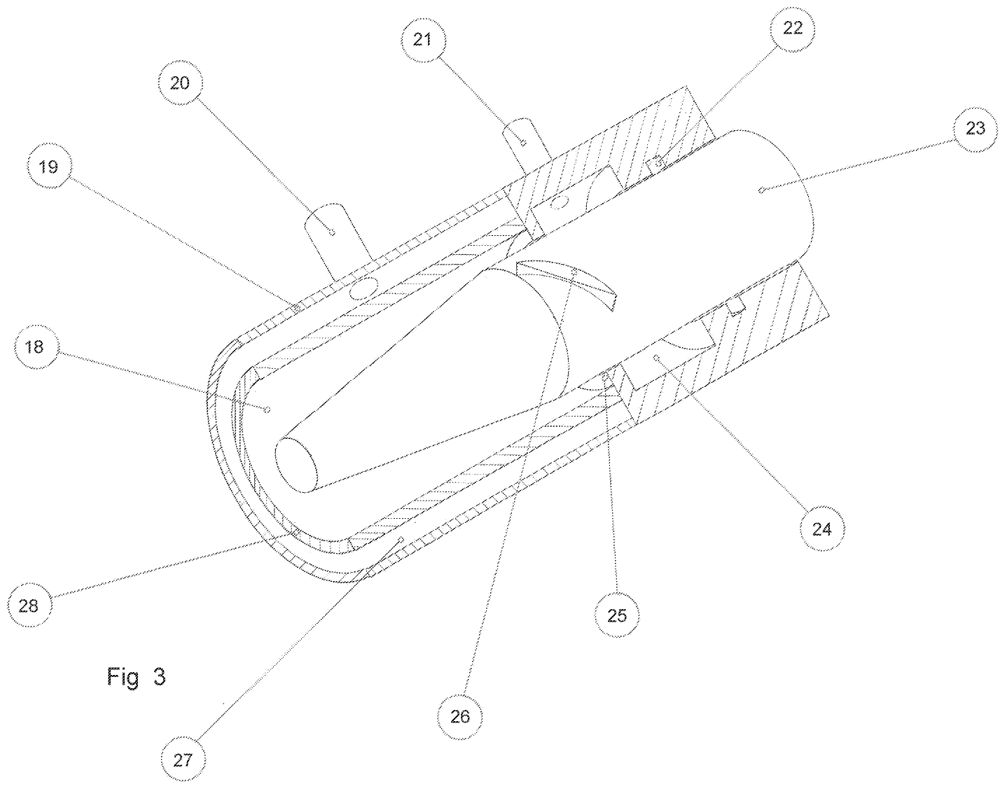

The apparatus of FIG. 3 comprises an outer structure comprising an outer jacket (19) and an inner structure inside the outer structure and a gas space (27) between the outer structure and inner structure. The gas space (27) is an annular chamber. Further, the apparatus comprises a gas inlet (20) for injecting the gas to the gas space (27) between the outer structure and inner structure. Further, the apparatus comprises a liquid feed pipe (21), a liquid feed annular chamber (24) and liquid inlets for feeding the liquid into the inner structure to provide a swirl flow. A closing ring (25) is arranged between a liquid feed annular chamber (24) and a bubble forming area of the inner structure. Further, the apparatus comprises an outlet for discharging a liquid-gas mixture (18) out from the apparatus.

A wall (28) of the inner structure comprises holes. The gas is arranged to flow through the holes from the gas space (27) into the inner structure. The wall (28) of the inner structure may be a sinter structure which is formed from a net material. The size of the holes in the sinter structure is 3-6 μm in this example.

The inner structure is designed such that volume of the space inside the inner structure increases in the direction of the liquid flow. The apparatus comprises a core (23) which comprises a conical inner shaft. The conical inner shaft which is tapering towards to the outlet is arranged inside the inner structure. The core (23) can be moved in longitudinal direction. An O-ring part (22) is arranged to provide a sealing between the liquid feed annular chamber (24) and the core (23). The core (23) comprises a cut (26) on side of the core. The cut (26) with the closing ring (25) form a nozzle. The core may comprise several cuts (26) with the nozzles, which are arranged in a circle of the core, for providing the swirl liquid flow inside the inner structure. The swirl flow of the liquid is arranged to capture gas bubbles of the gas from an inner surface of the wall (28) in order to form the liquid-gas mixture, which comprises small bubbles. Volume of the space inside the inner structure increases in the direction of the liquid flow. In the inner structure, a rate of the liquid-gas flow can be kept constant when a volume fraction of the gas increases.

In the process according to FIG. 3, the gas is injected continuously from the outer structure to the inner structure such that the gas flows through the holes of the wall to the inner surface of the wall. The swirl flow of the liquid captures small initial gas bubbles from the inner surface of the wall, by means of a shear stress. The liquid-gas mixture with micro-size bubbles is provided in the inner structure, and the liquid-gas mixture is discharged via the outlet.

The apparatus is suitable in different embodiments for using in different industrial processes. The apparatus and method are suitable in different embodiments for dissolving gas in liquid.

The invention is not limited merely to the examples referred to above; instead many variations are possible within the scope of the inventive idea defined by the claims.

1. An apparatus for enhancing dissolution of gas in liquid, the apparatus comprising:
an outer structure and at least one inner structure inside the outer structure;
at least one gas inlet for injecting the gas to a gas space between the outer structure and inner structure;
a wall of the inner structure which comprises holes, and the gas is arranged to flow through the holes into the inner structure;
at least one liquid inlet for feeding the liquid into the inner structure to provide a swirl flow and the swirl flow of the liquid is arranged to capture gas bubbles of the gas from an inner surface of the wall to form a liquid-gas mixture; and
at least one outlet for discharging the liquid-gas mixture out from the apparatus, wherein
the inner structure is designed such that volume of the space inside the inner structure increases in a direction of the liquid flow.

2. The apparatus according to claim 1, wherein the inner structure comprises a conical inner shaft which is tapered toward the outlet.

3. The apparatus according to claim 1, wherein the apparatus comprises two or more of the inner structures inside the outer structure.

4. The apparatus according to claim 1, wherein the liquid inlets are arranged to a desired angle to provide the swirl liquid flow inside the inner structure.

5. The apparatus according to claim 1, wherein the liquid inlets are arranged to a 35-55 degree angle to provide the swirl liquid flow inside the inner structure.

6. The apparatus according to claim 1, wherein the liquid inlets are arranged to feed the liquid via the liquid inlets for providing the swirl flow and for contacting with the gas near the inner surface of the wall of the inner structure.

7. The apparatus according to claim 1, wherein the liquid inlets are arranged to feed the liquid via the liquid inlets for moving the liquid flow along the inner surface of the wall by a centrifugal force.

8. The apparatus according to claim 1, wherein the wall of the inner structure is one or more of a porous or a sinter structure.

9. The apparatus according to claim 1, wherein a size of the holes in the wall of the inner structure is 1-100 μm.

10. A method for enhancing dissolution of gas in liquid, the method comprising:
using an apparatus which comprises an outer structure and at least one inner structure inside the outer structure and in which a wall of the inner structure comprises holes and in which the inner structure is designed such that volume of an inner space inside the inner structure increases in a direction of a liquid flow;
injecting the gas via at least one gas inlet to a gas space between the outer structure and inner structure;
arranging the gas to flow through the holes of the wall from the gas space to the inner structure;
feeding the liquid via at least one liquid inlet into the inner structure to provide a swirl flow, and arranging the swirl flow of the liquid to capture gas bubbles of the gas from an inner surface of the wall to form a liquid-gas mixture; and
discharging the liquid-gas mixture via at least one outlet out from the apparatus.

11. The method according to claim 10, wherein the liquid is fed via the liquid inlets to provide the swirl flow and to contact with the gas near the inner surface of the wall of the inner structure, wherein the swirl liquid flow captures the gas bubbles of the gas from the inner surface of the wall to permit a diffusion the gas into the liquid.

12. The method according to claim 10, wherein the liquid flow is arranged to move along the inner surface of the wall by a centrifugal force.

13. The method according to claim 10, wherein the liquid is fed at a desired angle by the liquid inlets to provide the swirl liquid flow inside the inner structure.

14. A method of using the apparatus according to claim 1, wherein the method includes using the apparatus in a gas-liquid separation process, chemical conversion process, dissolution of gas, CO2 separation process, CO2 capture process, crystallization of solids, precipitation process, biogas purification, biomethane purification, hydrogen injection for biological methanation, air or oxygen injection into liquid, gas absorption process, ejector arrangement, aerobic sewage treatment, or a combination thereof.
